(19) United States
(12) Patent Application Publication
(10) Pub. No.: US 2025/0020507 A1
(43) Pub. Date: Jan. 16, 2025

(54) PHOTOMETRIC APPARATUS, CALIBRATION SYSTEM, CALIBRATION METHOD, AND NON-TRANSITORY RECORDING MEDIUM

(71) Applicant: Konica Minolta, Inc., Tokyo (JP)

(72) Inventor: Satoshi MASUDA, Osaka (JP)

(21) Appl. No.: 18/762,173

(22) Filed: Jul. 2, 2024

(30) Foreign Application Priority Data
Jul. 10, 2023 (JP) 2023-113009

(51) Int. Cl. G01J 1/02; G01J 1/42

(52) U.S. Cl. CPC G01J 1/0295; G01J 1/42

(57) ABSTRACT

A photometric apparatus includes: a dimming member disposed so as to be insertable in and removable from a light path of light to be measured from a display; and a hardware processor that acquires a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path.

### CROSS-REFERENCE TO RELATED APPLICATION

The disclosure of Japanese Patent Application No. 2023-113009 filed on Jul. 10, 2023, including description, claims, drawings, and abstract, is incorporated herein by reference in its entirety.

### BACKGROUND OF THE INVENTION

### 1. Technical Field

The present invention relates to a photometric apparatus capable of measuring luminance, chromaticity, and the like of light emitted from a display such as a smartphone or a liquid crystal monitor, a calibration system and a calibration method for calibrating the photometric apparatus, and a non-transitory recording medium.

### 2. Description of Related Art

As a photometric apparatus as described above, as illustrated in FIG. 12, there is known a photometric apparatus 100 provided with a splitting optical system 120 for splitting light 201 to be measured from a display 200 into a plurality of light rays (for example, Japanese Patent No. 5454675).

This photometric apparatus includes an objective optical system 110 including a convex lens or the like, the splitting optical system 120, and colorimetric optical systems 130 to 150. As an example, a bundle fiber is used for the splitting optical system 120. The bundle fiber is formed by bundling a plurality of strand fibers having a small diameter. On the emission end (exit) side of the bundle fiber, the plurality of strand fibers are randomly branched into a plurality of pieces, and the plurality of pieces are bundled in groups of the pieces. The number of branches is, for example, three corresponding to tristimulus values of color-matching functions X, Y, and Z defined by the Commission Internationale de l'Eclairage (CIE). Furthermore, a diffuser plate may be used as the splitting optical system 120.

As the colorimetric optical systems 130 to 150, for example, wavelength-selective filters and light receiving sensors that are light receiving elements are used in combination in a number equal to the number of branches of the splitting optical system 120.

Light received by the light receiving sensors is converted into electrical signals, electrical processing sections 161a to 161c perform processing such as I/V conversion and amplification on the electrical signals, and the electrical signals are input to a controller 162 as received light data. The controller 162 performs calculation based on the input received light data to calculate a measured value.

In recent years, displays having a wide luminance dynamic range have been used in smartphones and the like. For this reason, the photometric apparatus 100 is required to have capability to measure luminance from low luminance to high luminance in performing gamma inspection, adjustment, or the like.

In order to widen the dynamic range of the photometric apparatus 100, it is necessary to control the amount of received light due to constraints on the photoelectric conversion capability of the light receiving sensors (saturation of the light receiving sensors) and the design conditions of the electrical processing sections 161a to 161c. Therefore, it is conceivable to insert and remove, in accordance with the brightness of the display 200, a dimming member into and from the light path of the light 201 that is to be measured and has been emitted from the display 200 and will enter the light receiving sensors.

However, when the dimming member is inserted and removed in order to widen the dynamic range, a difference in measured values between a state in which the dimming member is inserted and a state in which the dimming member is not inserted occurs.

Therefore, in order to eliminate the difference due to the insertion and removal of the dimming member, it is conceivable to calibrate the photometric apparatus. For such calibration, it is necessary to perform photometry in two states, that is, a state in which the dimming member is inserted in the light path of the light to be measured and a state in which the dimming member is not inserted in the light path of the light to be measured and to generate a calibration coefficient by using the acquired photometric values.

In a case where the light emission of the display is stable, specifically, in a case where the light emission cycle is constant and a waveform of emitted light is also invariable, the calibration coefficient satisfying the required accuracy is generated by performing the simple photometry in the two states.

However, as will be described below, it has been found by the research of the inventor that it is difficult to secure sufficient accuracy of a calibration coefficient for a recent display.

That is, as illustrated in a waveform of emitted light in FIG. 13A, a waveform of emitted light becomes complicated with the improvement of the functions and performance of the display. For example, in the case of an organic light-emitting diode (OLED) display, in order to implement faithful color reproduction, light emission control in which not only amplitude modulation but also pulse width modulation are combined with gradation control is adopted, and light emission with a high amplitude and a complicated waveform is generalized. In particular, in the pulse width modulation, a plurality of types of pulse light emission control are performed in one frame period (vertical synchronization cycle), the waveform of emitted light is sped up compared to an image update cycle, and the waveform is steep and has a high amplitude. The vertical axis of the waveform illustrated in FIG. 13A indicates a luminance value, the horizontal axis of the waveform illustrated in FIG. 13A indicates time, and a vertical synchronization signal Vsync is 60 Hz.

In recent years, a display having a variable refresh rate (VRR) function has been developed. The refresh rate is dynamically and aperiodically switched in this display, and therefore, the waveform of emitted light becomes increasingly complicated, for example, a transient response is observed in the waveform of emitted light from a switching point.

Furthermore, as illustrated in FIG. 13B, which illustrates changes in the luminance value when the luminance value is measured with 1/60 seconds as one frame, the waveform of emitted light has instability such as a short-term drift rising to the right as indicated by an arrow S1 and an aperiodic level difference as indicated by an arrow S2. In FIG. 13B, luminance value errors normalized by an average luminance value Lv are plotted on the vertical axis, and frame numbers, that is, points of time are plotted on the horizontal axis.

The drift is a gradual increase and decrease in the luminance value with the lapse of time, and the luminance value increases as indicated by the arrow S1 with the lapse of time. A main cause of the drift is heat generation of an information device including the display. The aperiodic level difference is an irregular large change in the luminance value. The aperiodic level difference occurs due to combined factors such as “temperature feedback” and a “cycle of an image data update for VRR”.

When calibration for the insertion and removal of the dimming member is performed using such a delicate display, a calibration value fluctuates every time the calibration is performed. Therefore, the same linear characteristic is not obtained in measured values in the state in which the dimming member is not inserted in the light path and the state in which the dimming member is inserted in the light path, and a level difference occurs in measured values due to the switching of the insertion and removal of the dimming member. As a result, it has been found that although the dynamic range is expanded by the incorporation of the dimming member, there arises a problem that accurate measurement cannot be performed in a high luminance range where the dimming member is in an inserted state.

### SUMMARY OF THE INVENTION

An object of the present invention is to provide a photometric apparatus, a calibration system, a calibration method, and a non-transitory recording medium capable of performing highly accurate calibration for suppressing an error caused by insertion and removal of a dimming member into and from a light path regardless of light emission characteristics of a display.

A first aspect of the present invention relates to
a photometric apparatus including:
a dimming member disposed so as to be insertable in and removable from a light path of light to be measured from a display; and
a hardware processor that acquires a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path, wherein
the hardware processor acquires, as photometric values for generating the calibration coefficient, at least a total of three or more photometric values measured in each of the states when switching is performed at least two or more times, the switching including switching from the state in which the dimming member is inserted in the light path to the state in which the dimming member is not inserted in the light path and switching from the state in which the dimming member is not inserted in the light path to the state in which the dimming member is inserted in the light path.

A second aspect of the present invention relates to a calibration method for calibrating a photometric apparatus including a dimming member disposed so as to be insertable in and removable from a light path of light to be measured from a display, the calibration method including:
acquiring a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path, the acquired photometric values being at least a total of three or more photometric values measured in each of the states when switching is performed at least two or more times, the switching including switching from the state in which the dimming member is inserted in the light path to the state in which the dimming member is not inserted in the light path and switching from the state in which the dimming member is not inserted in the light path to the state in which the dimming member is inserted in the light path; and
generating the calibration coefficient using the acquired photometric values.

A third aspect of the present invention relates to
a non-transitory recording medium storing a program readable by a computer of a photometric apparatus including a dimming member disposed so as to be insertable in and removable from a light path of light to be measured from a display, the program causing the computer to acquire a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path, wherein
the photometric values are at least a total of three or more photometric values measured in each of the states when switching is performed at least two or more times, and are photometric values for generating the calibration coefficient, the switching including switching from the state in which the dimming member is inserted in the light path to the state in which the dimming member is not inserted in the light path and switching from the state in which the dimming member is not inserted in the light path to the state in which the dimming member is inserted in the light path.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is an overall configuration diagram of a calibration system according to a first embodiment of the present invention;

FIG. 2 is a block diagram illustrating an internal configuration of a photometric apparatus;

FIG. 3 is a block diagram illustrating a configuration of a controller;

FIG. 4 is a flowchart for explaining an ND calibration method by the calibration system illustrated in FIG. 1;

FIG. 5 is a table illustrating an example of photometric conditions for ND calibration in the present embodiment;

FIG. 6 is a diagram in which timings of acquiring photometric values are plotted in the same drawing as FIG. 13B;

FIG. 7 is a diagram for explaining a measurement error remaining after the ND calibration;

FIG. 8A is a diagram illustrating a measurement error in a conventional method;

FIG. 8B is a diagram illustrating a measurement error in the first embodiment;

FIG. 9 is an overall configuration diagram of a calibration system according to a second embodiment of the present invention;

FIG. 10 is a flowchart for explaining a method of ND calibration by the calibration system illustrated in FIG. 9;

FIG. 11 is an overall configuration diagram of a calibration system according to still another embodiment of the present invention;

FIG. 12 is a configuration diagram of a general tristimulus value type photometric apparatus;

FIG. 13A is a diagram illustrating an example of a waveform of light emitted from a display; and

FIG. 13B is a diagram illustrating a short-term drift and an aperiodic level difference that occur in the waveform of emitted light.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described with reference to the drawings.

### First Embodiment

In a first embodiment, an example will be described in which, in a tristimulus value type photometric apparatus, a calibration application is used to perform calibration (matrix calibration) for insertion and removal of a dimming member for four display colors, white (W), red (R), green (G), and blue (B). In the following description, the calibration application is also referred to as a “calibration app”, and calibration for suppressing an error caused by insertion or removal of the dimming member is also referred to as “ND calibration”. In addition, a state related to insertion or non-insertion of the dimming member in a light path of light to be measured is also described as an “ND state”, a state in which the dimming member is inserted in the light path is also described as an “ND state”, and a state in which the dimming member is not inserted in the light path is also described as a “non-ND state”.

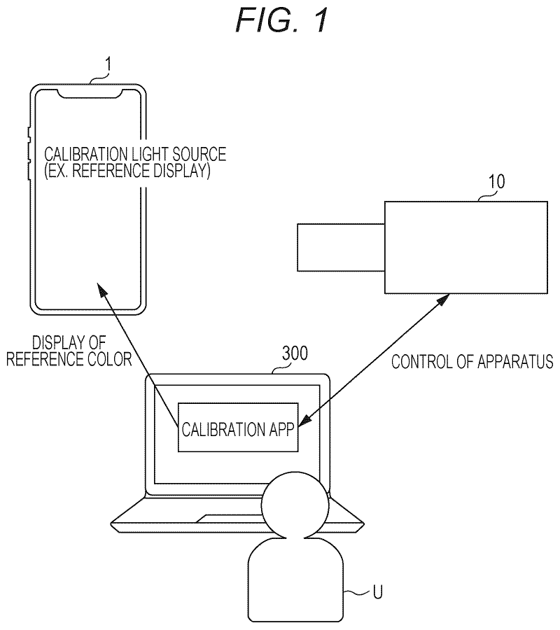

FIG. 1 is an overall configuration diagram of a calibration system according to the first embodiment of the present invention. The calibration system includes a photometric apparatus 10, an information processing apparatus 300 such as a personal computer, and a display 1.

The information processing apparatus 300 controls the entire calibration system. Specifically, when the ND calibration is performed, the information processing apparatus 300 controls the light emission state of the display 1 while communicating with the display 1 and the photometric apparatus 10 based on the calibration app. Further, the information processing apparatus 300 causes the photometric apparatus 10 to acquire a photometric value for generating a calibration coefficient and calculate and generate the calibration coefficient.

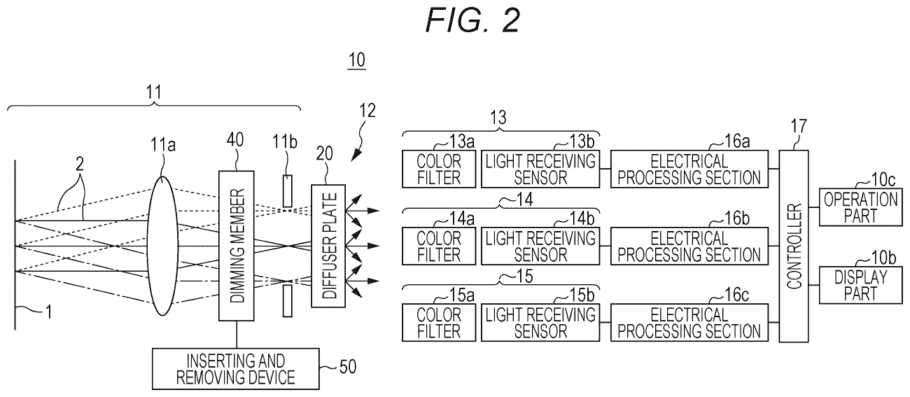

FIG. 2 is a block diagram illustrating an internal configuration of the photometric apparatus 10.

In FIG. 2, the photometric apparatus 10 is used, for example, in an inspection process for a manufacturing line of a display of a smartphone, and measures brightness, chromaticity, and the like of a display surface of the display 1.

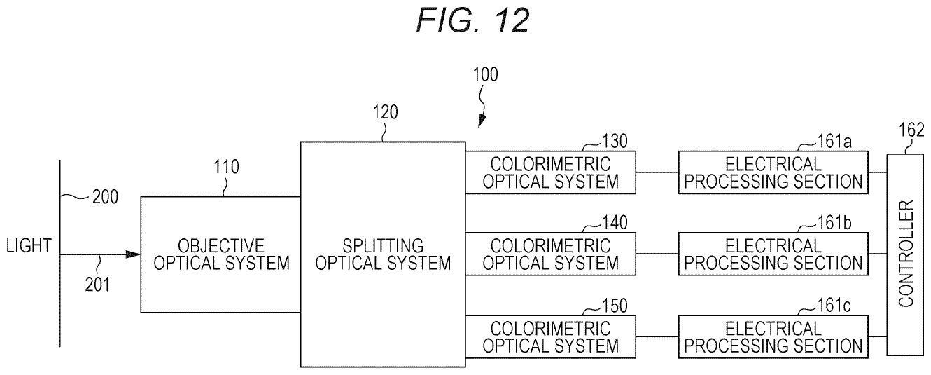

The photometric apparatus 10 includes an objective optical system 11, a splitting optical system 12, colorimetric optical systems 13 to 15, and a dimming member 40. A convex lens 11a having positive power is used in the objective optical system 11. A diffuser plate 20 having functions of splitting and diffusing is used in the splitting optical system 12. Note that a bundle fiber having branches on the emission end side as illustrated in FIG. 12 may be used instead of the diffuser plate 20.

An aperture diaphragm 11b is disposed at a rear-side focal position of the convex lens 11a, and a front telecentric optical arrangement is formed in order to take in light components within an angular range of ±2.5 degrees with respect to a normal line of a surface to be measured which is the display surface of the display 1. The diffuser plate 20 is disposed behind a surface of the aperture diaphragm 11b.

The dimming member 40 is disposed between the convex lens 11a and the diffuser plate 20 and in front of a surface of the aperture diaphragm 11b. The dimming member 40 is driven by an insertion and removal device 50 so as to be inserted into or removed from a light path of light 2 to be measured. The insertion and removal device 50 is a driving device. The inserting and removing device 50 includes, for example, a linear actuator. In a state in which the dimming member 40 is inserted in the light path of the light 2 to be measured, the amount of the light 2 to be incident on the diffuser plate 20 and to be measured is reduced by the dimming member 40. In a state in which the dimming member 40 is removed from the light path of the light 2 to be measured, the light 2 to be measured enters the diffuser plate 20 without a decrease in the amount of the light.

The dimming member 40 is inserted and removed in accordance with to the brightness of the display 1. To be more specific, the dimming member 40 is in a removed state when the display 1 is dark, and is inserted in the light path when the display 1 is bright, thereby preventing saturation of light receiving sensors 13b, 14b, and 15b by reducing the amount of the light. As a result, the intensity of the light 2 to be measured is within a dynamic range of the light receiving sensors 13b, 14b, and 15b, and as a result, the dynamic range of the photometric apparatus 10 is expanded.

It is desirable that the dimming member 40 be arranged close to a light collecting position (the position of the aperture diaphragm 11b) of the objective optical system 11. In the light path of the light 2 to be received and measured, an effective light path at the position of the aperture diaphragm is short. As the effective light path is shorter, the size of the dimming member 40 may be smaller, the size of the inserting and removing device 50 may be smaller, and the driving torque may be lower. Therefore, the product becomes compact, the weight becomes light, and the cost becomes low. The aperture diaphragm 11b may not be provided.

As the dimming member 40, various members such as a thin film filter, a glass absorption filter, and a porous plate can be used. The thin film filter has good flatness with respect to spectral transmittance and high reliability with respect to environmental temperature. Therefore, the thin film filter is preferably used as the dimming member 40.

The colorimetric optical systems 13, 14, and 15 include wavelength-selective filters 13a, 14a, and 15a, which are color-matching function filters corresponding to the tristimulus values of X, Y, and Z, and light receiving sensors 13b, 14b, and 15b, which are light receiving elements used in combination with the wavelength-selective filters 13a, 14a, and 15a, respectively.

Light received by the light receiving sensors 13b, 14b, and 15b is converted into electrical signals, the electrical signals are subjected to processing such as I/V conversion and amplification in the corresponding electrical processing sections 16a, 16b, and 16c, and are then input as received light data to a controller 17. The controller 17 performs calculation based on the input received light data to calculate a measured value.

Furthermore, the photometric apparatus 10 includes a display part 10b and an operation part 10c. An operation screen, a message, and the like are displayed on the display part 10b. The operation part 10c is used for operating the photometric apparatus 10. The operation part 10c may be formed of a touch screen of the display part 10b, may be formed of operation buttons or the like provided on a housing of the photometric apparatus 10, or may be formed of the touch screen and the operation buttons or the like.

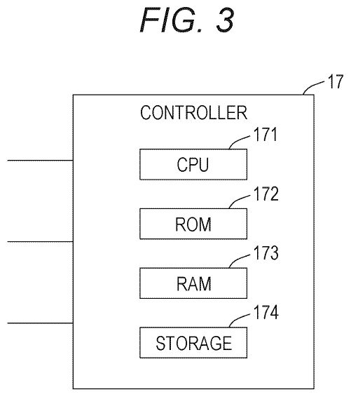

FIG. 3 illustrates a configuration of the controller 17. The controller 17 includes a CPU 171, a ROM 172, a RAM 173, a storage 174, and the like.

The CPU 171 operates in accordance with an operation program to comprehensively control the entire photometric apparatus 10. For example, the CPU 171 receives signals from the electrical processing sections 16a to 16c at the time of measurement of the display 1, performs a correction using a calibration coefficient as necessary, and calculates a final measured value. Furthermore, in the present embodiment, during ND calibration performed in a factory at the time of shipment or during ND calibration performed in accordance with a user's instruction after shipment, the CPU 171 acquires photometric values for generation of a calibration coefficient in a state in which the dimming member 40 is inserted in the light path of the light 2 to be measured and a state in which the dimming member 40 is not inserted in the light path of the light 2 to be measured. The CPU 171 performs processing such as generating an ND calibration coefficient using the acquired photometric values, but the processing will be described in detail later.

The ROM 172 is a memory for storing predetermined setting values and other information. The RAM 173 is a memory that provides a work area when the CPU 171 operates in accordance with the operation program.

The storage 174 includes a storage medium such as a hard disk device or an SSD. The storage 174 stores an application, an operation program for the CPU 171, and various types of data such as photometric values for generating an ND calibration coefficient, the generated ND calibration coefficient, and measured values of luminance, chromaticity, and the like after correction using the calibration coefficient.

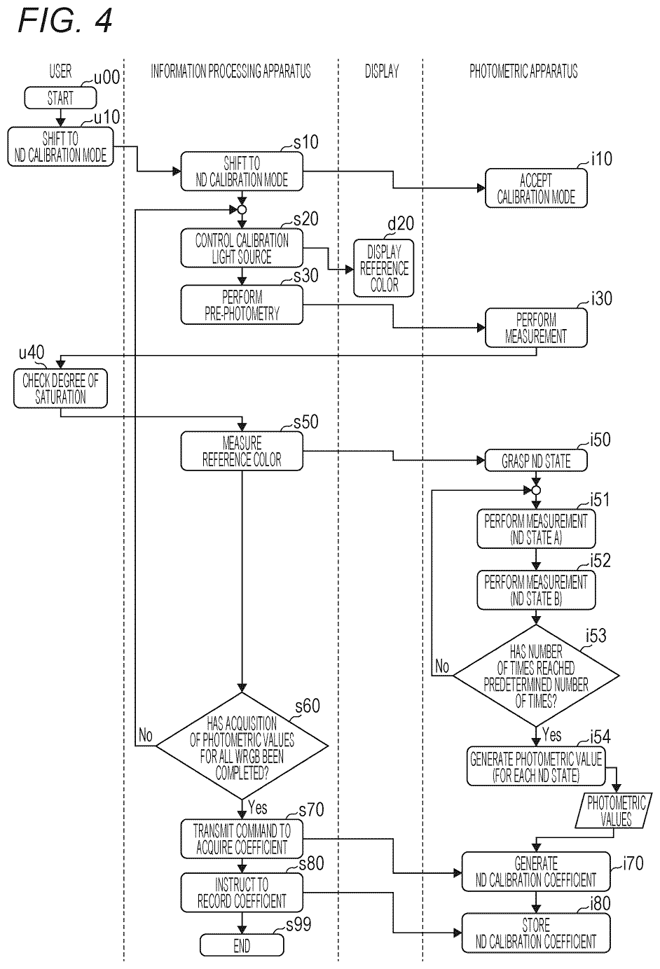

Next, a method of the ND calibration by the calibration system illustrated in FIG. 1 will be described with reference to a flowchart of FIG. 4. Processing illustrated in the flowchart of FIG. 4 is executed based on an operation performed by a user U on the information processing apparatus 30 and furthermore a signal transmitted and received to and from the information processing apparatus 300 and the display 1 or the photometric apparatus 10. As the display 1, for example, a reference display having a calibration light source is used.

When the user U instructs the information processing apparatus 300 to shift to an ND calibration mode in step u10, the information processing apparatus 300 instructs the photometric apparatus 10 to shift to the ND calibration mode in step s10, and the photometric apparatus 10 accepts the calibration mode in step i10.

The information processing apparatus 300 controls the calibration light source of the display 1 in step s20, and causes the display 1 to display a color of a preset reference value (RGB gradations, brightness) in step d20. In the present embodiment, the display color is any one of four colors WRGB.

Next, the information processing apparatus 300 transmits an instruction to perform pre-photometry to the photometric apparatus 10 in step s30, and the photometric apparatus 10 measures a pre-photometric value in step i30. The purpose of the pre-photometry is to optimize photometric conditions for “performing reference color measurement” in step s50. If unnecessary, it may not be performed.

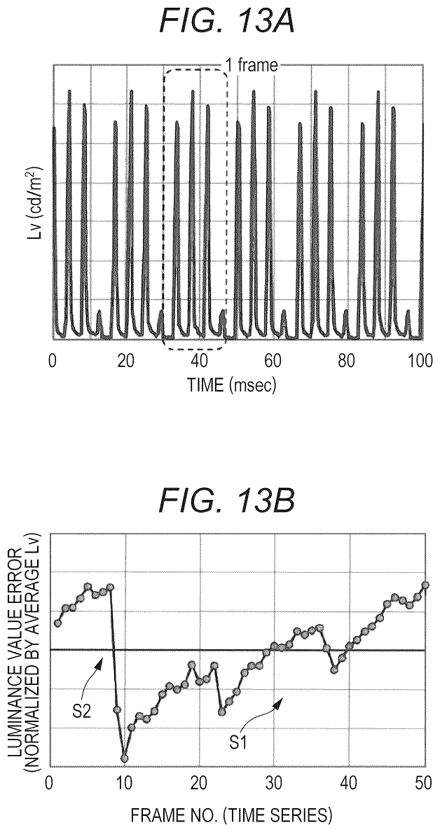

However, the waveform of light emitted from the display 1 is complicated and unstable as illustrated in FIG. 13A and FIG. 13B. For example, since the amount of heat generation differs depending on the display color and the intensity of emitted light, the aperiodic characteristics (e.g., a time interval at which an aperiodic level difference occurs and the amount of the level difference) differ for each reference value (for each of WRGB) at the time of the ND calibration. Furthermore, individual variations occur.

By measuring the intensity of the emitted light and the waveform in the pre-photometry, it is possible to acquire the degree of pulsation of light emission (the ratio of the peak intensity and the average intensity) and instability (drift and aperiodic level difference). Then, a photometric condition is derived based on the acquired pre-photometric information. An example is as follows.

(1) From the average intensity obtained by the pre-photometry, the exposure time for securing the S/N is obtained. Since the amounts of light incident on the light receiving sensors 13b, 14b, and 15b differ due to insertion and removal of the dimming member 40, the exposure time is obtained for each of the state in which the dimming member 40 is inserted in the light path and the state in which the dimming member 40 is not inserted in the light path, that is, for each ND state.

(2) From the peak intensity obtained by the pre-photometry, a circuit gain for avoiding saturation is obtained for each ND state.

(3) From the instability obtained by the pre-photometry, the number of times of switching between insertion and removal of the dimming member for suppressing the aperiodic level difference is obtained.

Furthermore, the degree of saturation may be derived based on the pre-photometry information, and the user U may be notified of the derived degree of saturation.

Here, the degree of saturation is an indicator that indicates the ratio of the actually measured intensity to the intensity of emitted light with which the ND calibration can be performed. The intensity of emitted light with which the ND calibration can be performed is the intensity of light that can be measured without saturation of the light receiving sensors in a state in which the dimming member 40 is not inserted in the light path. This intensity is also correlated with instability (for example, the amount of a level difference).

Since the user U is notified of the saturation, the following effects are obtained.

That is, under the display condition in which the degree of saturation is 100% or less and as high as possible, the dynamic range of the photometric apparatus 100 can be more effectively used, and thus the accuracy of the calibration is improved.

Furthermore, since the degree of saturation is also correlated with instability, it is possible to use the degree of saturation for management of the quality of the display 1 and feedback to design, such as making the degree of saturation the same.

Furthermore, the vertical synchronization frequency Vsync of the display 1 may be derived in this step. In this case, the user U is freed from the troublesomeness of setting the vertical synchronization frequency Vsync.

In step u40, the user U checks the degree of saturation notified from the photometric apparatus 100. In a case where it is determined that the degree of saturation is not appropriate (e.g., over 100% or more, under 10%, or the like), forced termination may be performed. Alternatively, the process may return to the control of the calibration light source in step s20, and the display conditions may be controlled to be changed.

In a case where the degree of saturation is appropriate, the user U instructs the information processing apparatus 300 to measure a reference color, and in response to this instruction, the information processing apparatus 300 instructs the photometric apparatus 10 to measure the reference color in step s50.

The photometric apparatus 10 that has received this instruction grasps, in step i50, the state (ND state) of the dimming member 40, that is, whether the dimming member 40 is in a state of being inserted in the light path or in a state of not being inserted in the light path. When one of the state in which the dimming member 40 is inserted in the light path and the state in which the dimming member 40 is not inserted in the light path is referred to as an ND state A and the other of the states is referred to as an ND state B, the photometric apparatus 10 measures and acquires a photometric value in the ND state A in step i51. Next, in step i52, the photometric apparatus 10 measures and acquires a photometric value in the ND state B. The photometry is basically performed at an interval of an integer multiple of the vertical synchronization cycle Tsync=1/Vsync.

In step i53, the photometric apparatus 10 determines whether or not the number of times of switching including switching from the ND state B to the ND state A and switching from the ND state A to the ND state B has reached a predetermined number of times equal to or greater than 2. In the present embodiment, the photometric apparatus 10 counts the number of times of switching by regarding each of switching from the ND state A to the ND state B and switching from the ND state B to the ND state A as one time of switching. Therefore, for example, when the dimming member 40 is inserted into the light path and is removed from the light path, the number of times of switching is counted as one, and when the dimming member 40 is inserted into the light path again, the number of times of switching is counted as two in total, and thereafter, the number of times of switching is incremented by one each time the removal or the insertion is performed.

When, in step i53, the number of times of switching has not reached the predetermined number of times that is two or more (NO in step i53), the photometric apparatus 10 returns to step i51 and performs switching of the ND state and photometry. When the predetermined number of times has been reached (YES in step i53), the process proceeds to step i54.

In the flowchart of FIG. 4, in a case where the number of times of switching does not reach the predetermined number of times, the photometry in the ND state A and the photometry in the ND state B are performed, and thus the number of photometric values acquired in the ND state A and the number of photometric values acquired in the ND state B are the same. For example, when the number of times of switching is three times, the photometry in the ND state A, the switching, the photometry in the ND state B, the switching, the photometry in the ND state A, the switching, and the photometry in the ND state B are performed in this order, and the number of photometric values acquired in the ND state A is two, and the number of photometric values acquired in the ND state B is two.

However, the number of photometric values in the ND state A may be different from the number of photometric values in the ND state B. For example, the number of times of switching may be set to two, the photometry in the ND state A, the switching, the photometry in the ND state B, the switching, and the photometry in the ND state A may be performed in this order, and the number of photometric values acquired in the ND state A may be two and the number of photometric values acquired in the ND state B may be one, that is, a total of the photometric values may be three. Furthermore, for example, the number of times of the switching may be four times, the number of photometric values acquired in the ND state A may be three, and the number of photometric values acquired in the ND state B may be two.

In short, it is sufficient that the switching is performed two or more times and the number of photometric values acquired in either one of the ND state A and the ND state B is two or more, the number of photometric values acquired in the other of the ND state A and the ND state B is one or more, that is, a total of three or more photometric values are acquired.

Returning to the flowchart of FIG. 4, in step i54, the photometric apparatus 10 averages the photometric values acquired in each of the ND state A and the ND state B, and sets this average value as a photometric value for each ND state used to generate the calibration coefficient.

In the present embodiment, as described above, the simple average is used for the generation of the photometric value for each ND state, but the effect of instability is further reduced and the accuracy is improved by performing the following processing.

That is, the photometric apparatus 10 performs processing for excluding an abnormal value. The photometric apparatus 10 extracts, for example, discontinuous points in time series and eliminates portions corresponding to the discontinuous points. Alternatively, the photometric apparatus 10 extracts a spike-like abnormal value and eliminates a portion corresponding to the abnormal value.

Further, the photometric apparatus 10 weights the average. For example, in time series, the photometric apparatus 10 detects the amount of a drift, weights each of measured values according to a degree of change, and averages the measured values.

Note that in the present embodiment, the number of times of the switching between the insertion and removal of the dimming member 40 is determined by pre-photometry, but a mode in which the user U can specify the number of times of the switching may be provided. For example, in the case of the calibration of the display 1 using a stable light source, the effect of shortening the calibration time is obtained by setting the number of times of the switching to 1, and it is possible to perform selective use according to the display 1 to be used. In addition, the user U can control the calibration time (number of times) and the accuracy by himself/herself.

Steps i50 to 54 are performed by the photometric apparatus 10 itself, but are not limited thereto. For example, the information processing apparatus 300 may perform the management and the control.

In step s60, the information processing apparatus 300 checks whether or not acquisition of photometric values for the four colors WRGB has been completed. In a case where the acquisition is not completed (NO in step s60), the process returns to step s20 and the information processing apparatus 300 controls the display 1 to emit light in another reference color.

In this way, the photometry is performed while the ND state is switched for each reference color, and there are a reference color priority method and an ND state priority method as switching methods. The reference color priority method is a method in which the ND state is switched with a fixed reference color, and when the photometry of one reference color is completed, the ND state is switched for the next reference color. On the other hand, the ND state priority method is a method in which a reference color is switched in a fixed ND state (for example, the ND state A), and the photometry is performed, and when the photometry in the ND state A is ended, the state is switched to the ND state B and fixed, the reference color is switched, and the photometry is performed.

In this embodiment, the reference color priority method is adopted, and the reference color priority method has the following effects.

That is, since the time difference between the data in the ND states becomes short, it is possible to suppress a calibration error caused by the drift. Furthermore, since the data for each ND state becomes continuous in time series, the effect of the level difference is suppressed by averaging even when an aperiodic level difference is included in the data.

On the other hand, also in the ND state priority method, the effect of improving the accuracy of the ND calibration can be expected. This ND state priority method is suitable because the calibration time can be shortened in a case where a measuring device in which the switching time of the ND state is long is used.

Returning to the flowchart of FIG. 4, when the acquisition of the photometric values for all of the four colors is completed (YES in step s60), the information processing apparatus 300 transmits a command to acquire an ND calibration coefficient to the photometric apparatus 10 in step s70, and the photometric apparatus 10 generates the ND calibration coefficient in step i70.

An example of generating the ND calibration coefficient is as follows. That is, when the tristimulus values calculated from the photometric values in a state in which the dimming member 40 is inserted in the light path are defined as S_{1(W, R, G, B)} and the tristimulus values calculated from the photometric values in a state in which the dimming member 40 is not inserted in the light path are defined as S_{2(W, R, G, B)}, an ND calibration coefficient N satisfying S_{2(W, R, G, B)}≈N·S_{1(W, R, G, B)} is calculated and generated.

The ND calibration coefficient is a calibration coefficient for calibrating an error caused by the insertion and removal of the dimming member 40. The ND calibration coefficient may be a calibration coefficient generated using photometric values acquired in the state in which the dimming member 40 is inserted in the light path and in the state in which the dimming member 40 is not inserted in the light path. The ND calibration may be factory calibration performed in a factory or may be user calibration performed based on an instruction of a user U of the photometric apparatus 10.

The information processing apparatus 300 instructs the photometric apparatus 10 to record the ND calibration coefficient in step s80, and then ends the control processing in step s99. The photometric apparatus 10 that has received the instruction to record the ND calibration coefficient stores the generated ND calibration coefficient in a storage 140 in step i80.

In this embodiment, the photometric apparatus 10 generates the ND calibration coefficient, but the information processing apparatus 300 may acquire the photometric values in each ND state from the photometric apparatus 10, generate the ND calibration coefficient, and transmit the generated ND calibration coefficient to the photometric apparatus 10 and causes the photometric apparatus 10 store the ND calibration coefficient therein.

In actual measurement of the light to be measured from the display 1, the acquired photometric values are corrected using the ND calibration coefficient stored in the storage 174, to obtain a final measured value.

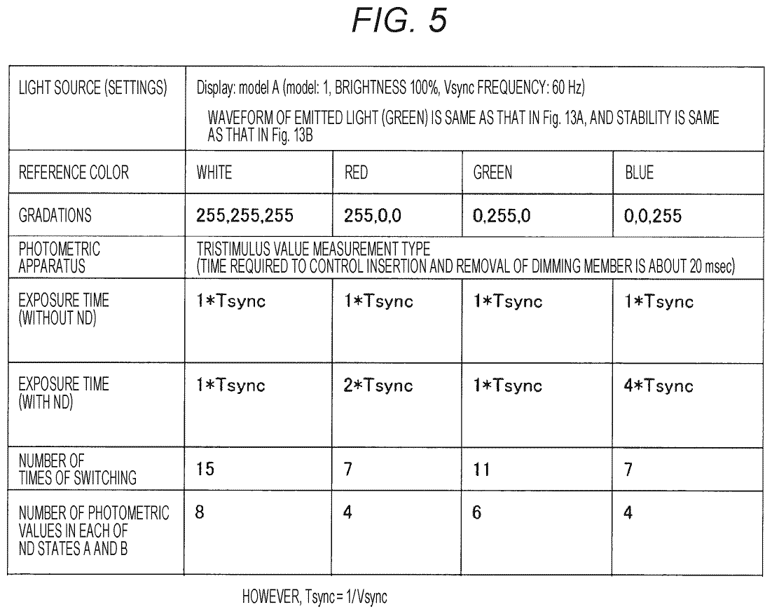

FIG. 5 is a table illustrating an example of photometric conditions at the time of the ND calibration in the present embodiment. In the table illustrated in FIG. 5, the waveform of emitted light of the reference color G (green) is the waveform illustrated in FIG. 13A, and the stability of the waveform is the same as that illustrated in FIG. 13B. Different conditions are set for the exposure time, the number of times of switching, and the like for the reference colors.

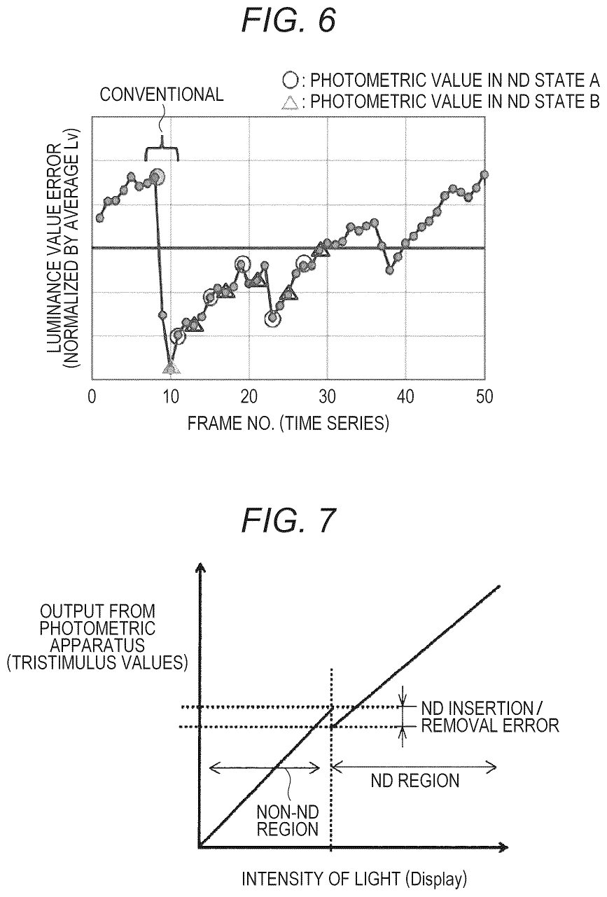

Next, effects of the present embodiment will be described with reference to FIGS. 6 to 8 by taking the case of the reference color green as an example.

FIG. 6 is a diagram in which timings of acquiring photometric values are plotted in the same drawing as FIG. 13B. Note that the time required to control insertion and removal of the dimming member 40 of the photometric apparatus 10 used for measurement is about 20 msec. Therefore, the photometric values acquired by the photometric apparatus 10 in the ND state A and the ND state B are substantially the same as the photometric values at intervals of about one point among the photometric values illustrated in FIG. 6.

From the table of FIG. 5, regarding the reference color green, the measurement was performed while switching between the ND state A and the ND state B is performed eleven times. In FIG. 6, circle marks indicate measured values in the ND state A, triangle marks indicate measured values in the ND state B, and a total of twelve photometric values, six each at intervals of about one point, are acquired. A combination of the first black circle mark and the next black triangle mark indicates a case where the ND calibration coefficient is generated by only one switching, and is described as a conventional example.

When the ND calibration is performed based on photometric values acquired by the switching of one time, as illustrated in FIG. 6, in a case where the photometric values are acquired and include an aperiodic level difference by chance at the time of the calibration, a large error occurs.

On the other hand, in the calibration system according to the present embodiment, even in a case where an aperiodic level difference is included, a plurality of (in this example, six) values are measured while switching between the ND state A and the ND state B is performed twice or more (in this example, eleven times), and each average value or the like is adopted as a photometric value, so that it is possible to significantly reduce an error.

This effect is explained as follows by using a measurement error remaining after the ND calibration, that is, the amount of an error between the insertion and removal of the dimming member 40. Here, as illustrated in FIG. 7, the amount of an error between the insertion and removal of the dimming member 40 is a relative error amount generated in the photometric apparatus 10 with respect to the tristimulus values when switching between a state in which the dimming member 40 is inserted in a high luminance range and a state in which the dimming member 40 is not inserted in a low luminance range is performed. In FIG. 7, the high luminance region is described as a ND region. In FIG. 7, the low luminance region is described as a non-ND region. In FIG. 7, the relative error amount is described as an ND insertion/removal error.

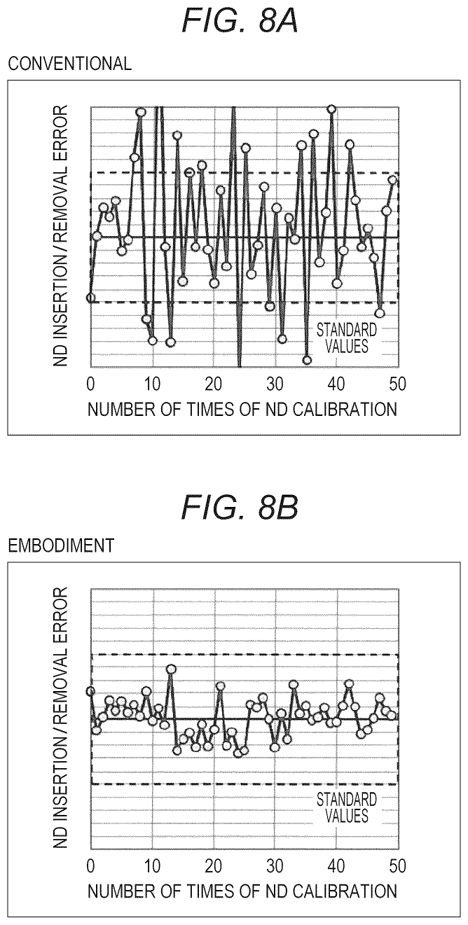

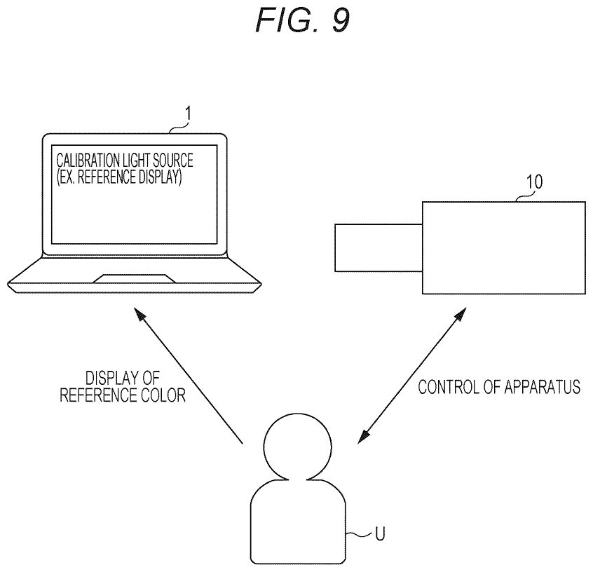

FIG. 8A illustrates ND insertion/removal errors when ND calibration is performed by a conventional method. In this evaluation, a series of operations in which an ND calibration coefficient is obtained from each photometric value in the conventional method in which the number of times of switching is one and the ND insertion/extraction errors are obtained by using the generated calibration coefficient is repeated 50 times. FIG. 8A is a diagram in which the ND insertion/removal errors when the calibration is performed 50 times are plotted. On the other hand, in the ND calibration in which the number of times of the switching is 11 and an ND calibration coefficient is obtained from each six photometric values in the present embodiment, ND insertion/extraction errors when the calibration is performed 50 times are illustrated in FIG. 8B.

FIGS. 8A and 8B illustrate an ND insertion/extraction error generated at each time of calibration. From a comparison between FIG. 8A and FIG. 8B, it is understood that, in the present embodiment, the ND insertion/removal errors are suppressed more and fall within an allowable range indicated by broken lines in FIGS. 8A and 8B. Furthermore, since the amount of variation in the ND insertion/removal errors is smaller in the present embodiment, it is understood that the present embodiment is more stable. Therefore, in the present embodiment, a highly accurate calibration coefficient can be generated with good reproducibility.

Note that even if the photometry is performed in each of the ND state A and the ND state B successively to perform the ND calibration, such an error reduction effect as in the present embodiment cannot be expected. For example, even if photometry is continuously performed in the ND state A over six periods of a vertical synchronization signal, and then the state is switched to the ND state B to perform photometry continuously for the same period to perform ND calibration, such an error reduction effect as in the present embodiment cannot be expected. That is, even if the total exposure time is simply increased so as to be the same amount as the present embodiment, the averaging effect is low.

When the number of times of switching between the ND state A and the ND state B is set as follows, it is possible to both “improve the accuracy of the ND calibration” and “reduce the calibration time”. That is, the total exposure time is set as long as possible within a range in which one aperiodic level difference is included within the total time required for exposure for the ND calibration.

### Second Embodiment

FIG. 9 is an overall configuration diagram of a calibration system according to a second embodiment of the present invention. The calibration system includes a photometric apparatus 10 and a display 1, and a user directly controls the display 1 and the photometric apparatus 10 to perform ND calibration (matrix calibration) on four display colors WRGB.

The configuration of the photometric apparatus 10 is the same as that of the photometric apparatus 10 according to the first embodiment illustrated in FIG. 1, and thus a description thereof will be omitted.

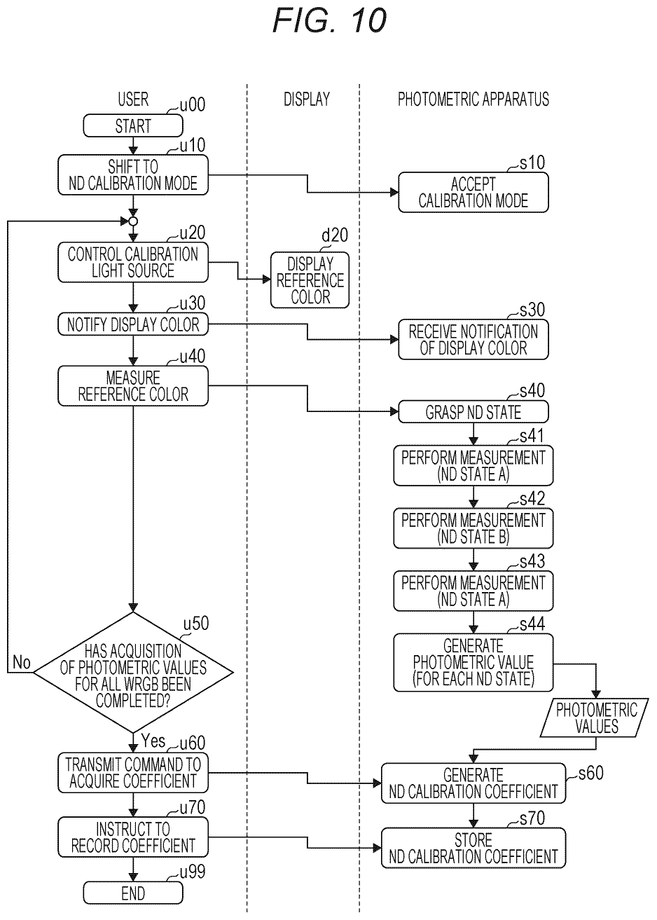

Next, a method of the ND calibration by the calibration system illustrated in FIG. 9 will be described with reference to the flowchart of FIG. 10. A process illustrated in the flowchart of FIG. 10 is performed based on an operation by the user U on the display 1 and the photometric apparatus 10. As the display 1, for example, a reference display which is a calibration light source is used.

When the user U instructs the photometric apparatus 10 to shift to an ND calibration mode in step u10, the photometric apparatus 10 accepts the ND calibration mode in step s10.

The user U controls the calibration light source (display 1) in step u20, and causes the display 1 to display a color of a preset reference value (RGB gradations, brightness) in step d20. It is preferable to set the brightness to a predetermined recommended intensity range. The recommended intensity is determined from the S/N and the dynamic range of the system.

The user U notifies the photometric apparatus 10 of the display color in step u30, and the photometric apparatus 10 receives the notification of the display color in step s30. Note that instead of the notification of the display color, the photometric apparatus 10 may have a function of identifying the display color from a photometric value. For example, when the photometric apparatus 10 is of a tristimulus value type, the display color is easily identified from the balance of the acquired XYZ. Identifying the display color leads to an improvement in usability because an operation mistake is eliminated.

Further, it is preferable that the photometric apparatus 10 has a function of selectively receiving the display intensity. By having the intensity information in advance, photometry under a proper condition becomes possible, and the accuracy of the calibration is improved. On the other hand, it is not essential because setting by the user becomes complicated.

Furthermore, the user U instructs the photometric apparatus 10 to measure a reference color in step u40. The notification of the display color in step u30 may be performed at the same time as the instruction of the execution of the measurement in step u40. The photometric apparatus 10 which has received the instruction grasps the ND state of the dimming member 40, that is, a state in which the dimming member 40 is inserted in a light path or a state in which the dimming member 40 is not inserted in the light path in step s40. In a case where the dimming member 40 is inserted in the light path (ND state), the photometric apparatus 10 changes the state to the state in which the dimming member 40 is not inserted. In a case where the dimming member 40 is not inserted (non-ND state), the photometric apparatus 10 maintains the state.

By setting the non-ND state, the following effects are obtained. That is, since the ND state is switched twice, the number of times of switching to the ND state in which photometry is performed first is increased to 2. For this reason, there is an advantage in that the calibration time can be shortened by performing photometry first for a shorter exposure time (a larger amount of light in the non-ND state). Furthermore, since the non-ND state is measured first, there is also an effect that the accuracy of determination of the degree of appropriateness with respect to the intensity of light emitted from the light source is improved. Provided that only the grasp of the ND state may be performed without performing the switching to the non-ND state.

Next, in steps s41 to s43, the photometric apparatus 10 measures and acquires a photometric value by switching the ND state twice. The photometry is basically performed at an interval of an integer multiple of the vertical synchronization cycle Tsync=1/Vsync.

Next, in step s44, the photometric apparatus 10 sets a photometric value obtained for each ND state as the photometric value for each ND state used to generate a calibration coefficient. The photometric apparatus 10 averages values acquired in the ND states measured twice to obtain a photometric value.

In step u50, the user U checks whether acquisition of photometric values for four colors WRGB has been completed. When the acquisition of the photometric values for all of the four colors is not completed (NO in step u50), the process returns to step u20 and the user U controls the display 1 to emit light of another reference color.

When the acquisition of the photometric values for all of the four colors is completed (YES in step u50), the user U transmits a command to acquire an ND calibration coefficient to the photometric apparatus 10 in step u60, and the photometric apparatus 10 generates the ND calibration coefficient in step s60.

The user U instructs the photometric apparatus 10 to record the ND calibration coefficient in step u70, and then ends the control processing in step u99. The photometric apparatus 10 that has received the instruction to record the ND calibration coefficient stores the generated ND calibration coefficient in the storage 140 in step s70.

According to the second embodiment, since the switching of the ND state is performed twice, for example, in a case where a drift is linearly changing, the average value of two photometric values acquired in the ND state A matches the average value of two photometric values acquired in the ND state B, it is possible to suppress an ND calibration error caused by instability due to the drift. Therefore, both the shortening of the ND calibration time and the accuracy of the calibration are achieved.

Although the embodiments of the present invention have been described above, the present invention is not limited to the above-described embodiments.

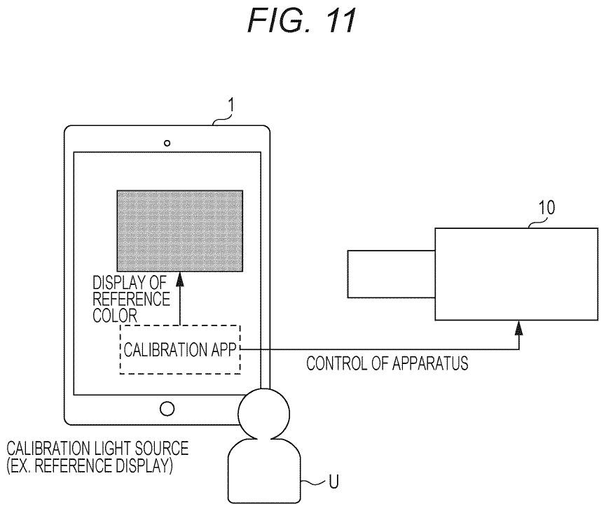

For example, as illustrated in FIG. 11, the calibration app may be installed and incorporated in the display 1 including the calibration light source, and the calibration app may control the photometric apparatus 10 at the time of the ND calibration.

In addition, the ND calibration using the four colors (WRGB) has been described, but the present invention is not limited thereto, and the calibration may be, for example, one-point calibration of only W (white).

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A photometric apparatus comprising:
a dimming member disposed so as to be insertable in and removable from a light path of light to be measured from a display; and
a hardware processor that acquires a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path, wherein
the hardware processor acquires, as photometric values for generating the calibration coefficient, at least a total of three or more photometric values measured in each of the states when switching is performed at least two or more times, the switching including switching from the state in which the dimming member is inserted in the light path to the state in which the dimming member is not inserted in the light path and switching from the state in which the dimming member is not inserted in the light path to the state in which the dimming member is inserted in the light path.

2. The photometric apparatus according to claim 1, wherein the hardware processor generates the calibration coefficient using the acquired photometric values for generating the calibration coefficient.

3. The photometric apparatus according to claim 1, wherein in a case where a plurality of reference colors are provided for calibration, the hardware processor changes at least one of the number of times of the switching and a photometric condition in accordance with the reference colors.

4. The photometric apparatus according to claim 1, wherein the photometric value corresponding to the state in which the dimming member is inserted in the light path and the photometric value corresponding to the state in which the dimming member is not inserted in the light path are generated from a weighted average value.

5. The photometric apparatus according to claim 1, wherein a user can specify the number of times of the switching.

6. The photometric apparatus according to claim 1, wherein the hardware processor acquires the photometric values when the switching between the insertion and the removal of the dimming member is performed in a state in which a reference color is set.

7. The photometric apparatus according to claim 1, wherein the hardware processor performs pre-photometry before acquiring the photometric values and notifies a user of a degree of saturation.

8. The photometric apparatus according to claim 1, wherein the acquisition of the photometric values by the hardware processor is started from the state in which the dimming member is not inserted in the light path.

9. A calibration system comprising:
the photometric apparatus according to claim 1; and
a device that generates the calibration coefficient by using the photometric values for generating the calibration coefficient acquired by the hardware processor of the photometric apparatus.

10. The calibration system according to claim 9, wherein in a case where a plurality of reference colors are provided for calibration, at least one of the number of times of the switching and a photometric condition is changed in accordance with the reference colors.

11. The calibration system according to claim 9, wherein the photometric value corresponding to the state in which the dimming member is inserted in the light path and the photometric value corresponding to the state in which the dimming member is not inserted in the light path are generated from a weighted average value.

12. The calibration system according to claim 9, wherein a user can specify the number of times of the switching.

13. The calibration system according to claim 9, wherein the hardware processor of the photometric apparatus acquires the photometric values when the switching between the insertion and the removal of the dimming member is performed in a state in which a reference color is set.

14. The calibration system according to claim 9, wherein pre-photometry is performed before the photometric values are acquired by the hardware processor of the photometric apparatus, and a user is notified of a degree of saturation.

15. The calibration system according to claim 9, wherein the acquisition of the photometric values by the hardware processor of the photometric apparatus is started from the state in which the dimming member is not inserted in the light path.

16. A calibration method for calibrating a photometric apparatus including a dimming member disposed so as to be insertable in and removable from a light path of light to be measured from a display, the calibration method comprising:
acquiring a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path, the acquired photometric values being at least a total of three or more photometric values measured in each of the states when switching is performed at least two or more times, the switching including switching from the state in which the dimming member is inserted in the light path to the state in which the dimming member is not inserted in the light path and switching from the state in which the dimming member is not inserted in the light path to the state in which the dimming member is inserted in the light path; and
generating the calibration coefficient using the acquired photometric values.

17. A non-transitory recording medium storing a program readable by a computer of a photometric apparatus including a dimming member disposed so as to be insertable in and removable from a light path of light to be measured from a display, the program causing the computer to acquire a photometric value of the light to be measured in a state in which the dimming member is inserted in the light path and a photometric value of the light to be measured in a state in which the dimming member is not inserted in the light path in order to generate a calibration coefficient for suppressing a measurement error between the state in which the dimming member is inserted in the light path and the state in which the dimming member is not inserted in the light path, wherein
the photometric values are at least a total of three or more photometric values measured in each of the states when switching is performed at least two or more times, and are photometric values for generating the calibration coefficient, the switching including switching from the state in which the dimming member is inserted in the light path to the state in which the dimming member is not inserted in the light path and switching from the state in which the dimming member is not inserted in the light path to the state in which the dimming member is inserted in the light path.
